(19) United States
(12) Patent Application Publication
(10) Pub. No.: US 2026/0098795 A1
(43) Pub. Date: Apr. 9, 2026

(54) Rheometer Device and Method for Determining Rheological Properties of Samples

(71) Applicant: NETZSCH-Gerätebau GmbH, Selb (DE)

(72) Inventors: Sabrina Küspert, Selb (DE); Florian Rummel, Selb (DE); Levente Szántó, Hof (DE); Rebekka Taubmann, Selb (DE)

(21) Appl. No.: 19/346,766

(22) Filed: Oct. 1, 2025

(30) Foreign Application Priority Data
Oct. 9, 2024 (EP) 24205701.6

(51) Int. Cl. G01N 11/02; G01N 11/00

(52) U.S. Cl. CPC G01N 11/02; G01N 2011/008

(57) ABSTRACT

A rheometric device for ascertaining rheological properties of samples. Such a rheometric device includes at least one measurement unit, a reception device having at least one drive unit, and an evaluation unit with its evaluation program, which is coupled in each case with the at least one measurement unit and the reception device. The reception device is thus configured to receive several sample vessels with respective sample contents, differing at least partly from one another, and to move them with precision, so that measurements can be executed in parallel and simultaneously on a number of sample contents in the respective sample vessels. In addition, a corresponding method is disclosed.

### TECHNICAL FIELD

The present invention relates to a rheometric device as well as a method for ascertaining rheological properties of samples.

### BACKGROUND

In order to measure rheological properties generally, such as viscosities, sheer viscosities, extensional viscosities, sheer stresses, or viscoelastic properties, samples that are to be examined are removed from their storage vessels and then placed in a suitable apparatus for measurement such as a rheometer. Samples for the purpose of measurement of the aforementioned properties are typically set in oscillation/vibration. Alternatively they may also be subjected to rotation or distension.

Accordingly, various rotational rheometers, capillary rheometers, falling-ball viscometers, or microfluid devices in general are already known from the prior art. Measurements performed by such means often include both absolute and relative measurement values.

Removing various samples from their storage vessels requires not only a certain technical expertise; in addition, it imposes increased time demands. Moreover, various samples can undergo structural impairments by being removed from their respective storage vessels, leading in the worst case to distortion of the findings. In addition to physical impairments, chemical or biological impacts on the respective samples can occur as a result of removal processes.

Typically with the aforementioned devices in the prior art, the respective samples may be measured only in sequence and/or by rheological means, a circumstance that further increases the time requirements and accordingly the costs per individual sampling event. In addition, for instance in samples not stable over time, comparability can be limited unless measurements are taken at the absolutely same time. Generally therefore, overall reproducibility and standardization of sample behavior in solutions from the prior art can be considered problematic.

In some exceptional cases, moreover, certain minimum quantities are required in terms of sample volumes to ensure precise measurement. This can be the case, above all, in applying methods based on mechanical dimensions, such as power measurements. In such cases certain minimal quantities of sample volume are required in order to generate any measurable signal of a relevant order of magnitude.

### SUMMARY

In view of these background considerations, the object of the present invention is to provide a rheometric device and a corresponding method that are capable of overcoming the aforementioned disadvantages, at least to some extent.

This object is fulfilled by a rheometric device having the characteristics of patent claim as well as a method with the characteristics of patent claim.

The invention accordingly foresees a rheometric device for ascertaining rheological properties of samples. Such a rheometric device comprises at least one measuring unit, a reception device having at least one drive unit, and an evaluation unit having an evaluation program, said evaluation unit being coupled with the at least one measuring unit and the reception device. The reception device moreover is so designed as to receive several sample containers, which are at least partly distinguished from one another, with their respective sample contents and also to move them with precision so that measurements can be performed simultaneously in parallel on a number of sample contents in the respective sample containers.

In addition, a corresponding method is foreseen for ascertaining rheological properties of samples. Such a method in this case comprises the following steps: providing an inventive rheometric device; placement of several sample containers. of which at least several are distinct from one another, along with respective sample contents on a reception device of the inventive rheometric device that is designed specifically for these purposes; activation of the reception device; activation and coupling of at least one measurement unit of the inventive rheometric device with the reception device; activation and coupling of an evaluation unit including evaluation program of the inventive rheometric device with the reception device and the at least one measurement unit; parallel and optionally simultaneous execution of rheological measurements on a number of sample contents in the respective sample containers by means of the at least one measurement unit; evaluation and issuing of the executed measurements by means of the evaluation unit with the evaluation program of the inventive rheometric device in real time.

One of the ideas on which the invention is based consists in providing technical solutions which make it possible to make rheological investigations of several samples simultaneously. The samples can accordingly be incorporated within various sample containers, and thus in several different ones, and nevertheless can be evaluated simultaneously, and thus essentially at the same time, by rheological means.

It is possible in this manner to evaluate a number of different samples in one essentially identical time period, so that the time requirements associated with the measurement methods required with devices from the prior art can be optimized and thus any time requirements, and/or their associated costs per sample being examined, can also be decreased.

It is further foreseen that the reception device is designed to accommodate several sample containers differing at least partly from one another, with respective sample contents, and subsequently to set them in motion by means of their at least one drive unit. This does not rule out the further accommodation of sample containers that are basically of identical construction and their respective sample contents, nor their treatment as defined in the present invention. The movements are accordingly applied to the samples, and rheological measurements can be executed simultaneously by means of the measurement unit in combination with the evaluation unit with its evaluation program.

In other words, the movements of the powered reception device are transmitted to the samples situated in the sample container or containers and/or to the material they contain, so that, in parallel, and particularly in real time, rheological measurements can be executed on several samples by means of the inventive rheometric device.

According to one embodiment of the rheometric device, the at least one measurement unit is positioned above the reception device so that contact-free measurements can be performed on the numerous sample contents in the respective sample vessels.

Contact-free measurements offer the great advantage that the samples need not be touched further by components of the measuring device, thus avoiding any risk of adverse effects to the structures of the sample. In addition, this allows chemical or biological impairments to be reduced to a minimum. At least, such impairment cannot occur as a result of one or more components of the measurement device coming into contact with the samples. Moreover, the various samples can remain within their respective sample vessels as long as access is assured in the direction of the measurement device.

According to one refinement of the rheometric device, the at least one measurement unit comprises: a video camera apparatus, microscope apparatus, fluorescence microscope, Raman apparatus.

These respective options make it possible to provide imaging processes in an advantageous manner, so that thereafter, or even in real time, an evaluation of rheological behavior of the samples becomes possible by means of the evaluation unit with its evaluation program. Because the various components of the inventive rheometric device are coupled with one another, it becomes possible for resulting respective details on the individual components to be combined in a way that can enable statements to be made about rheological behavior of the respective samples.

According to one embodiment of the rheometric device, the reception device can be moved with precision in at least one direction by means of at least one drive unit, making it possible to transmit these movements, at least in part, to sample vessels placed in the reception device and thus the sample contents in the sample vessels can be set in motion with precision.

The movements can thus be transmitted to the sample vessels and thereby indirectly to the samples found in said vessels. These transmitted movements, for example, can set the respective samples and/or the material contained in them into vibration or movements in just one direction. Because several drive units can assure this start-up of movements and/or movement impulses, also transmitted, precisely superposed movements are possible in diverse coordinate systems (for instance, cartesian). By means of at least one drive unit, the reception device can be configured to resemble an electrically movable table or the like or to resemble a movable microscope table or the like, or at least can be conceived partly in such a manner.

This feature offers the advantage of allowing even more information to be measured and/or detected concerning the samples to be measured, so that detailed analyses can be conducted.

According to a refinement of the rheometric device, the various sample vessels are constructed of various materials: Well plates, microfluid chambers, Well plates with integrated microfluid chambers, 96-Well plates, 384-Well plates, flasks for medicines, Falcon-tubes, object carriers.

In this particular embodiment, the reception device therefore includes corresponding means, so that the various aforementioned sample vessels can be received simultaneously and thus, in parallel, various measurements can be performed on the samples situated in these various sample vessels.

It is also conceivable that similar or even basically equivalent sample contents are situated in different kinds of sample vessels, and thus the movements registered by means of the at least one measurement unit accordingly can be evaluated by the evaluation unit with its evaluation program in multiple ways, so that particularly detailed measurement results are obtainable.

According to one embodiment of the rheometric device, at least two measurement units can be activated in parallel manner, so that, at least in part, a parallel evaluation of the respective measurements of the at least two measurement units can be executed in real time by means of the evaluation unit with its evaluation program.

In this manner, measurements can be performed in even greater detail, so that, accordingly, an ever more rapid and more efficient rheological characterization of the respective samples can be obtained simultaneously.

One refinement of the rheometric device includes at least one illumination unit, which can be coupled with the evaluation unit and its evaluation program, so that the sample contents to be measured can be illuminated with precision in the various sample vessels during the measurement process.

In this manner, in the various samples and/or in the material they contain, it becomes possible to trigger reactions which, corresponding to the reaction or reactions, modify the rheological behavior of the respective samples and can be evaluated rheologically or in addition with other methods (for instance, simultaneously).

According to one embodiment of the rheometric device, the at least one illumination unit comprises: a UV light illumination unit, an illumination unit designed to emit visible light, an illumination unit designed to emit infrared light, an illumination unit designed to emit polarized light, an illumination unit designed to emit fluorescent light, particularly blue, green, or red fluorescent light.

The individual samples and/or the material in them can thus be irradiated with UV light of defined wavelength or with UV light with a defined light spectrum, so that additional findings can be obtained by means of the measurement device and evaluation unit with its evaluation program. Fluorescent stimulation can also be provided, in which case the corresponding illumination unit has to be activated for this purpose.

Another refinement of the rheometric device can comprise at least one additional stimulation unit, connected contact-free with the sample vessels, so that the sample contents in the various sample vessels can be set in motion with precision and without contact, by means of the at least one additional stimulation unit.

The individual samples and/or the material they contain can thus be stimulated in various other ways and means, so that, by means of the measurement device and evaluation unit with its evaluation program, additional results can be obtained. This can be arranged in parallel to the actually initiated motions by means of the drive units of the reception device. Another possibility is to provide respective stimulations of the various samples, arranged sequentially to one another, at least in part, with the result that even more information can be provided for the actual rheological characterization.

In another embodiment of the rheometric device, the at least one additional stimulation unit is configured as an electromagnetic stimulation unit.

The advantage of an electromagnetic stimulation unit consists primarily in the fact that it can be operated easily and in a single step in order finally to obtain the desired effect. Its use in this particular embodiment is particularly relevant when the samples to be measured contain materials, at least in part, which can be set in vibration using this technique contact free, a basic necessity for making rheological measurements.

Another refinement of the rheometric device comprises a testing chamber with means of regulating environmental conditions inside the said testing chamber, in which at least one of the aforementioned components of the inventive rheometric device can be situated, at least partly, so that at least one environmental condition of the sample contents placed in the testing chamber can be regulated with precision by means of the testing chamber inside the sample vessels.

In this manner, additional factors for the rheological characterization of various samples can be controlled, so that accordingly even more information can be obtained for the actual rheological characterization. In another embodiment of the rheometric device, the adjustable environmental conditions inside the testing chamber comprise: temperature, pressure, relative humidity, (inert) gas atmosphere. The aforementioned advantages become even more obtainable as a result.

According to another refinement of the rheometric device, the evaluation unit with evaluation program comprises at least one rheological computation model to compute at least one rheological property of the sample contents, such that the inventive rheometric device is constituted to conduct an automatic selection of the rheological computation models depending on the respective detected sample container.

The information obtained by means of the at least one measurement unit can therefore be applied especially specifically, in order to perform a rapid, efficient rheological characterization of the respective samples simultaneously by means of the inventive rheometric device. The extensive automation, which enables recognition of the respective sample vessels, leads, in particular, to rapid and efficient execution of the desired measurements.

In another refinement of the inventive method, the at least one measurement unit is situated above the reception device, so that contact-free measurement of the numerous sample units can be performed.

As already mentioned in connection with the inventive device, non-contact measurements offer the important advantage that the samples are no longer required to be touched by components of the measurement device and thus the risk of adverse effects to sample structures is avoided.

This also allows chemical or biological impairments to be reduced to a minimum. At least, such impairment is not caused by the necessity of bringing one or more components of the measurement device into contact with the samples. Also, any samples can remain inside their respective sample vessels, as long as access is assured in the direction of the measurement device. The result is an especially reliable process at moderate price.

In another embodiment of the inventive method, motions of the reception device are caused and at least partly transmitted with precision to the sample vessels and thus to the sample contents in the sample vessels, in such a way that any measurements of the at least one measurement unit are performed in dependence on the respective motions.

The motions can thus be transmitted to the sample vessels and therefore indirectly to the samples contained in them. These transmitted motions, for example, are capable of setting in vibration the various samples and/or the material found there. Since several drive units can assure this activation of motions and/or motive impulses, well-defined superposed motions in diverse coordinate systems (for instance, cartesian) can also be performed.

In one refinement of the inventive method, various measurements are performed by at least two parallel activated measurement units, and thus at least partly a parallel evaluation of the respective measurements of the at least two measurement units can be conducted in real time by means of the evaluation unit with its evaluation program.

In this manner, by means of the inventive method, even more detailed measurements can be performed, and thus accordingly an even more rapid and more efficient rheological characterization of the various samples can be made simultaneously.

In one refinement of the inventive method, the sample contents to be measured in the respective sample vessels are illuminated with precision during the measurement process by means of at least one illumination unit of the inventive rheometric device that can be coupled with the evaluation unit and its evaluation program.

In this manner, in the various samples and/or in material found in those samples, reactions can be triggered that, according to the reaction or reactions, can modify the rheological behavior of the respective samples and can be evaluated rheologically or additionally with other methods (for example, simultaneously).

In another refinement of the inventive method, at least one additional stimulation unit of the inventive rheometric device is activated, which is linked without contact with the sample vessels or which is disposed at least partly in contact with the sample vessels or sample contents, or at least partly in contact with the sample vessels and at least partly with the sample contents, so that the sample contents in the various sample vessels can be set in motion with precision by means of the additional stimulation unit.

The individual samples and/or the material contained in them can thus be stimulated in other ways and means, and thus additional results can be obtained by means of the measurement device and the evaluation unit with its evaluation program. This effect can be obtained in parallel with the actual resulting movements by means of the drive units of the reception device. It is also conceivable to arrange stimulations of the various samples that are at least partly arranged in sequence, individually introduced, allowing even more information to be obtained for the actual rheological characterization.

In another refinement of the inventive method, at least one rheological computation model is selected for computing at least one rheological property of the sample contents by means of the evaluation unit with its evaluation program, depending on one sample vessel detected in each case by means of the inventive rheometric device.

Thus the information acquired by means of the at least one measurement unit can be applied with precision in order to conduct a rapid and efficient rheological characterization of the respective samples simultaneously by means of the inventive rheometric device. The extensive automation permitting recognition of the respective sample containers thus leads, in particular, to a rapid, efficient execution of the intended measurements.

### BRIEF DESCRIPTION OF THE DRAWINGS

The invention is described in greater detail with reference to the exemplary embodiments, as depicted in the attached drawings.

These drawings are included in order to allow further clarification of the invention; they are included in the description and constitute part of it. The drawings illustrate the embodiments of this invention and serve, together with the description, to clarify the principles of the invention.

Additional embodiments of this invention and many of its expected advantages can be further clarified by referring to the following extensive description. The elements of the drawings are not necessarily shown on the same scale. Identical reference numbers designate similar parts.

FIG. 1 shows a schematic depiction of a rheometric device according to one embodiment of the present invention.

FIG. 2 depicts a schematic flow diagram for a method of obtaining rheological properties of samples according to one embodiment of the present invention.

The same numbers in the drawings designate the same or functionally similar components, unless otherwise indicated. All indications of direction, such as “above,” “below,” “left,” “right,” “over,” “under,” “horizontal,” “vertical,” “behind,” “in front of” and similar terms are employed only for purposes of clarification and are not intended to restrict the embodiments to the specific indications depicted in the drawings.

### DETAILED DESCRIPTION

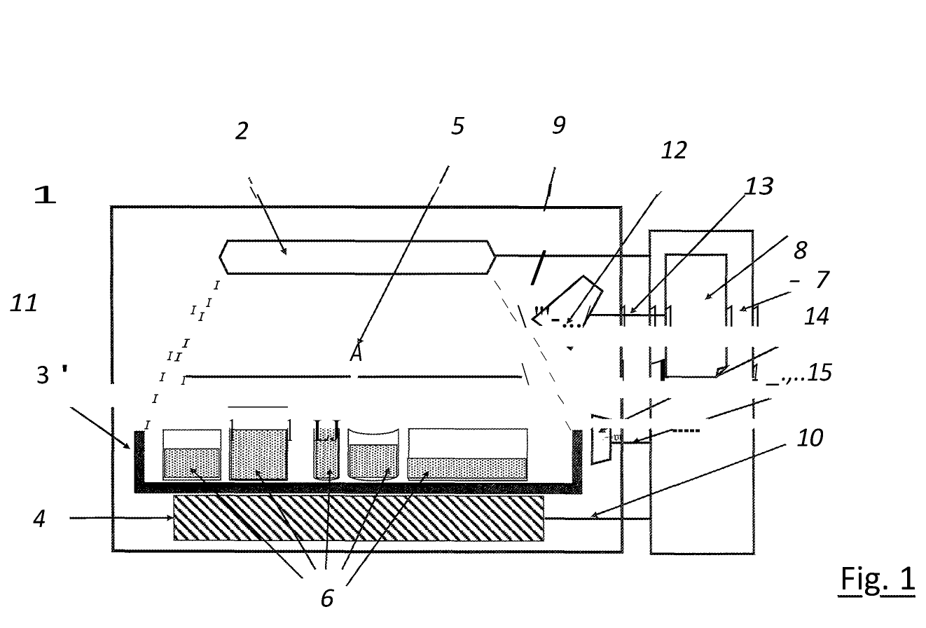

FIG. 1 shows a schematic view of a rheometric device 1 according to one embodiment of the present invention. The rheometric device 1 is depicted here with one measurement unit 2 and one reception device 3 having a drive unit 4.

It is possible in other embodiments (not illustrated), however, that more than one measurement unit 2 is foreseen, for example two or three such units, and more than one drive unit 4, for example two or three such units. It is also conceivable that the additional drive units 4 are disposed at least partly alongside the reception device 3.

It is also conceivable that at least one drive unit 4 is disposed alongside the reception device 3 and at least one drive unit 4 below the reception device 3, being in each case coupled or connected with the reception device 3 in such a way that motions or movement impulses of the drive units 4 in general, or the like, can be transmitted to the reception device 3 and thus to objects that are disposed on the reception device 3. Altogether five different sample vessels 5 are placed in the reception device 3, in such a way that sample contents 6 are foreseen in each of the sample vessels 5. The sample contents 6, for instance, can differ from one another. They may also be at least partly identical. This has the advantage, for example, that one rheological reaction can be analyzed for each sample vessel 5 and the degree of fullness. Thus the reception device 3 can also receive only one sample vessel 5 or a number of sample vessels 5 of identical kind.

The reception device 3 is depicted here, in very simplified form, as basically basin-like, although it is designed to accommodate several sample vessels 5, at least partly of different kinds, with their respective sample contents 6, and to move with precision, so that measurements on a number of sample contents 6 in the respective sample vessels 5 can be conducted in parallel and simultaneously. Alternatively, the reception device 3 can assume other shapes. For example, said reception device 3 can comprise an essentially round or oval working surface for the sample vessels 5 and their respective sample contents 6, which at least partly differ from one another.

In one embodiment that is not illustrated in detail, it is conceivable, for example, that the reception device 3 comprises containment spaces, for instance recesses or the like, for different types of sample vessels, so that, depending on the shape and nature of the sample vessels 5, a particular sample vessel 5 can be placed securely in a location specially foreseen for it in the reception device 3. This feature offers the advantage that, even during motions caused and transmitted by means of the at least one drive unit 4, these assorted sample vessels 5 can be disposed securely in the reception device 3, especially protected from being overturned or otherwise disturbed.

It is also conceivable that the reception device 3 includes a type of adjustable scaffolding or clamping elements or the like, so that the sample vessels 5 can be arranged so as to be safe, especially from being overturned or disturbed.

The measurement unit 2 is illustrated as disposed above the reception device 3, allowing contact-free measurements to be performed on the range of sample contents 6 in the respective sample vessels 5. The at least one measurement device 2 can be, for example, a video camera apparatus or a microscope device. A combination of those types of device is also possible. It is also conceivable for at least two video cameras and/or at least two microscope devices are used. Likewise at least two video cameras can each be placed at different camera angles with respect to a single field of vision, enabling sample contents 6 to be followed from two different perspectives, particularly in the course of their movements. It is also possible to provide, for instance, a fluorescence microscope, a Raman device and at least one video camera device.

Another possible feature in this context is that the various sample contents 6 can be assessed only on their surface. Otherwise the sample contents 6 can be studied both on the surface and through several layers. For instance, one could conceivably take at least one image per time unit on the surface on the respective sample contents 6, and then, layer by layer, record additional images for each time unit.

To this extent, then, it is possible that, by means of the inventive rheometric device 1, a single evaluation of the rheological behavior during an optical or spectroscopic action can be determined throughout a corresponding type of sample, on one surface or over multiple layers, and thus can be assessed throughout the entire sample volume in which the material response of volume elements or points in the material can be observed throughout space and time.

Thus, rheological values can be computed corresponding to the distribution of the material response in space and time.

The rheometric device 1, in addition, is depicted having an evaluation unit 7 with an evaluation program 8, coupled in each case with the at least one measurement unit 2 and the reception device 3. Here, the evaluation unit 7 is depicted as coupled with the measurement unit 2 by means of a first connection cable 9 and with the reception device 3 by means of a second connection cable 10. Alternatively to the illustrated connection cables 9, 10, radio connections are also possible, in which case the respective components accordingly include means for emitting and/or receiving data. The evaluation program 8, for example, can contain rheological models, which in each case can be adapted to different sample vessel shapes and sizes by mathematical adjustments.

The evaluation unit 7 with its evaluation program 8 can, for example, include at least one rheological computation model for computing at least one rheological property of the sample contents 6, whereby the rheometric device 1 is designed to conduct an automatic selection of the rheological computation models in dependence on the sample vessel 5 that is detected in each case.

The rheometric device 1, in addition, is depicted as having a testing chamber 11. Said testing chamber 11 is illustrated in markedly simplified manner and disposed in such a way that it houses the reception device 3 with the drive unit 4 and the measurement unit 2. Only the evaluation unit 7 is expected to be external to the testing chamber 11.

In other words, these components, that is, the reception device 3 with drive unit 4 and the measurement unit 2 of the rheometric device 1, are depicted as completely inside the testing chamber 11, so that at least one environmental condition of the sample contents 6 placed inside the testing chamber 11 in the sample vessels 5 can be regulated with precision by means of the testing chamber 11. The testing chamber 11 includes relevant means (which are not described in further detail) for regulating environmental conditions within the said testing chamber 11.

In an additional embodiment (not described in detail) of the inventive rheometric device 1, however, it is possible that at least one of the aforementioned components of the rheometric device 1 can be at least partly positioned inside the testing chamber 11, so that at least one environmental condition of the sample contents 6 placed in the testing chamber 11 can be regulated with precision in the sample vessels 5 by means of the testing chamber 11. For example, it is conceivable that the drive unit 4 will be only partly inside the testing chamber 11.

The adjustable environmental conditions within the testing chamber 11 can be, for example, temperature, pressure, relative air humidity, or (inert) gas atmosphere.

The rheometric device 1, in addition, is shown with an illumination unit 12, which likewise is illustrated as being inside the testing chamber 11. The said illumination unit 12 is intended to be coupled with the evaluation unit 7 and its evaluation program 8 by way of a third connection cable 13, and thus the sample contents 6 to be measured in the various sample vessels 5 during the measurement procedure can be illuminated with precision. By this means, reactions in the material and/or in the various sample contents 6 to be measured can be triggered in the various sample vessels 5, modifying the rheological behavior, and can be evaluated rheologically or by other methods, for instance simultaneously.

In other embodiments (not presented in detail) it is conceivable that more than one illumination unit 12, for example two or three illumination units 12, are to be used. These illumination units 12 can be activated simultaneously or at time intervals or even in sequence, so that respective illumination effects for the measurements can be controlled, and/or visually configured in general, for example with respect to a particular illumination duration or illumination intensity.

This at least one illumination unit 12 can be, for example, an UV light illumination unit, which is designed as adjustable, so that a user-defined illumination and/or user-defined illumination effects become possible.

In addition, the rheometric device 1 is depicted having another stimulation unit 14, which is mounted contact-free to the sample vessels 5, so that the sample contents 6 in the various sample vessels 5 can be set in motion by means of the stimulation unit 14 in a non-contact manner and measured with precision. This stimulation unit 14, in the illustration, is coupled with the evaluation unit 7 by a fourth connection cable. Alternatively to the foreseen functioning by means of the stimulation unit 14, it is conceivable that the inventive rheometric device 1 is so compact and mobile in configuration that it can be disposed without difficulty in an airplane or the like, which is outfitted for parachute flights, so that the inventive rheometric device 1 can be employed in a parachute flight and thus the active gravitational forces and/or their changing influences during such a parachute operation could become useful for measurements that are to be made as cited in various ways and means. Alternatively, use in a centrifuge is also conceivable, wherein the inventive rheometric device 1 can be accordingly configured for such an operational purpose.

In other embodiments not presented in detail here, it is conceivable that more than one stimulation unit 14 is foreseen, but rather two or three stimulation units 14 for example. Said stimulation unit 14 can be, for example, an electromagnetic stimulation unit.

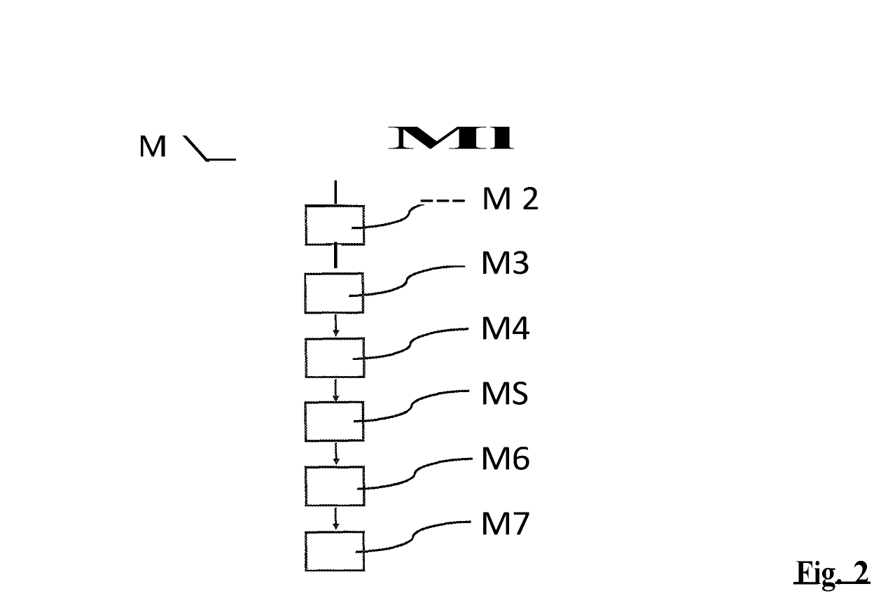

FIG. 2 shows a schematic flow diagram for a method M for ascertaining rheological properties of samples according to an embodiment of the present invention.

In a first step M1 of the method, an inventive rheometric device 1 is provided. In a second step M2, several sample vessels 5, partially differing from one another, are placed with their respective sample contents 6 on a reception device 3 of the inventive rheometric device 1 that has been configured for these purposes.

In a third step M3 of the method, the reception device 3 is activated. In a fourth step M4, at least one measurement unit 2 of the inventive rheometric device 1 is activated and coupled with the reception device 3.

In a fifth step M5 of the method, an evaluation unit 7 of the inventive rheometric device 1 with its evaluation program 8 is activated and coupled with the reception device 3 and the at least one measurement unit 2.

In a sixth step M6 of the method, rheological measurements are executed in parallel on a number of sample contents 6 in the respective sample vessels 5 by means of the at least one measurement unit 2. In a seventh step M7, concluded measurements are evaluated and issued in real time by means of the evaluation unit 7 of the inventive rheometric device 1 with evaluation program 8.

1. A rheometric device for ascertaining rheological properties of samples, comprising at least one measurement unit, a reception device having at least one drive unit and one evaluation unit with an evaluation program, which in turn is coupled with the at least one measurement unit and the reception device,
wherein the reception device is configured to receive several sample vessels with their respective sample contents, which differ at least partly from one another, and to move them with precision so that measurements on a number of sample contents in the respective sample vessels can be performed simultaneously in parallel.

2. The rheometric device according to claim 1, wherein the at least one measurement unit is disposed above the reception device, allowing contact-free measurements to be performed on the number of sample contents in respective sample vessels.

3. The rheometric device according to claim 1, wherein the at least one measurement unit comprises: video camera apparatus, microscope apparatus, fluorescence microscope, Raman probe.

4. The rheometric device according to claim 1, wherein the reception device can be moved with precision in at least one direction by means of at least one drive unit, so that these motions can be transmitted at least partly to sample vessels placed in the reception device and thus the sample contents in the sample vessels can be set in motion with precision.

5. The rheometric device according to claim 1, wherein the various sample vessels comprise: Well plates, microfluid chambers, Well plates with integrated microfluid chambers, 96-Well plates, 384-Well plates, flasks for medicines, Falcon tubes, object carriers.

6. The rheometric device according to claim 1, wherein at least two measurement units can be activated in parallel, so that, at least in part, a parallel evaluation of the various measurements of the at least two measurement units can by performed in real time by means of the evaluation unit with its evaluation program.

7. The rheometric device according to claim 1, wherein the rheometric device includes at least one illumination unit that can be coupled with the evaluation unit and its evaluation program, so that the sample contents to be measured can be illuminated with precision in the various sample vessels during the measurement process.

8. The rheometric device according to claim 7, wherein the at least one illumination unit comprises: UV light illumination unit, illumination light configured to transmit visible light, illumination unit configured to transmit infrared light, illumination unit configured to emit polarized light, illumination unit configured to emit fluorescent light, particularly blue, green or red fluorescent light.

9. The rheometric device according to claim 1, wherein the rheometric device includes at least one additional stimulation unit, which is connected contact-free to the sample vessels, so that the sample contents in the respective sample vessels can be set in motion with precision, contact free, by means of the at least one additional stimulation unit.

10. The rheometric device according to claim 9, wherein the at least one additional stimulation unit consists of: an electromagnetic stimulation unit.

11. The rheometric device according to claim 1, wherein the rheometric device includes a testing chamber with means for controlling the environmental conditions inside said testing chamber, in which at least one of the aforementioned components of the rheometric device is at least partly positional in each case, so that at least one environmental condition of the sample contents in the sample vessels which are placed in the testing chamber can be regulated with precision by means of the testing chamber.

12. The rheometric device according to claim 10, wherein the adjustable environmental conditions inside the testing chamber comprise: temperature, pressure, relative humidity, (inert) gas atmosphere.

13. The rheometric device according to claim 1, wherein the evaluation unit with its evaluation program includes at least one rheological computation model for computing at least one rheological property of the sample contents, wherein the rheometric device is configured to execute an automatic selection of the rheological computation models, depending on a respective detected sample vessel.

14. A method for ascertaining rheological properties of samples, comprising the following steps:
provision of a rheometric device having at least one measurement unit, a reception device having at least one drive unit and one evaluation unit with an evaluation program, which in turn is coupled with the at least one measurement unit and the reception device,
wherein the reception device is configured to receive several sample vessels with their respective sample contents, which differ at least partly from one another, and to move them with precision so that measurements on a number of sample contents in the respective sample vessels can be performed simultaneously in parallel;
placement of several sample vessels, at least partly different from one another, with respective sample contents, on a reception device of the rheometric device configured for this purpose;
activation of the reception device;
activation and coupling of at least one measurement unit of the rheometric device with the reception device;
activation and coupling of an evaluation unit and evaluation program of the rheometric device with the reception device and the at least one measurement unit;
parallel and optionally simultaneous execution of rheological measurements on a range of sample contents in the respective sample vessels by means of the at least one measurement unit;
• evaluation and issuing of the completed measurements by means of the evaluation unit and evaluation program of the rheometric device in real time.

15. The method according to claim 14, wherein the at least one measurement unit is positioned above the reception device, permitting contact-free measurement to be performed on the range of sample contents.

16. The method according to claim 14, wherein motions of the reception device are activated by means of at least one drive unit of the reception device and are at least partly transmitted with precision to the sample vessels and thus to the sample contents contained in the sample vessels, wherein various measurements of the at least one measurement unit are conducted in dependence on the respective motions.

17. The method according to claim 14, wherein various measurements are performed by means of at least two measurement units activated in parallel, so that, at least partly, parallel evaluation of the respective measurements of the at least two measurement units can be executed in real time by means of the evaluation unit with its evaluation program.

18. The method according to claim 14, wherein the sample contents to be measured in the various sample vessels during the measurement process are illuminated with precision by means of at least one illumination unit of the rheometric device that can be coupled with the evaluation unit and its evaluation program.

19. The method according to claim 14, wherein at least one additional stimulation unit of the rheometric device is activated, which is mounted contact-free on the sample vessels or which is disposed at least partly in contact with the sample vessels or with the sample contents or at least partly in contact with the sample vessels and at least partly with the sample contents, so that the sample contents in the various sample vessels can be set in motion without contact with precision by means of the additional stimulation unit.

20. The method according to claim 14, wherein at least one rheological computation model is selected for computing at least one rheological property of the sample contents by the evaluation unit with its evaluation program in dependence on a sample vessel detected in each case by means of the rheometric device.
